(19) United States
(12) Patent Application Publication
(10) Pub. No.: US 2026/0264750 A1
(43) Pub. Date: Sep. 10, 2026

(54) Method for Operating a Steer-By-Wire Steering System

(71) Applicant: Robert Bosch GmbH, Stuttgart (DE)

(72) Inventors: Arnulf Heilig, Schwaebisch Gmuend (DE); Florian Rochel, Schorndorf (DE); Holger Schmitt, Ettlenschiess (DE); Matthias Albrecht, Schechingen (DE)

(21) Appl. No.: 19/162,937

(22) PCT Filed: Jan. 25, 2024
(86) PCT No.: PCT/EP2024/051770

§ 371 Date: Sep. 7, 2025

(30) Foreign Application Priority Data
Mar. 9, 2023 (DE) 10 2023 202 119.6

(51) Int. Cl. B62D 6/00

(52) U.S. Cl. CPC B62D 6/008

(57) ABSTRACT

A method for operating a steer-by-wire steering system in a vehicle is disclosed. The steering system is to be controlled via a steering handle, and a driver manual torque, which includes a static driver manual torque and which can include a dynamic driver manual torque, is applied to the steering handle. The driver manual torque is determined on the basis of the driving situation of the vehicle, and the static driver manual torque is calculated on the basis of the steering angle and driving speed without taking into consideration the dynamic effects of the steering rack force.

The invention relates to a method for operating a steer-by-wire steering system and an arrangement for carrying out the method.

### PRIOR ART

Steering systems are used in motor vehicles to influence the direction of travel by the driver. Steering systems are known in which a direct mechanical coupling between the steered or steerable wheels and the steering handle used by the driver, typically a steering wheel, is interrupted. Such steering systems are referred to as steer-by-wire steering systems. In these cases, the wheel steering angle is controlled electrically.

A method for operating a steering system for a motor vehicle is known from the publication DE 10 2018 200 094 A1. The steering system comprises a steering handle and a manual torque adjuster associated with the steering handle, which in turn is configured to apply a damping force on the steering handle that counteracts the operation by the driver. Furthermore, a wheel angle adjuster coupled to at least one steerable wheel of the motor vehicle is provided, which is electrically actuated on the basis of an operation of the steering handle in order to adjust a steering angle of the at least one wheel. It is contemplated that the manual torque adjuster generates the damping force on the basis of a current performance of the wheel angle adjuster.

In steer-by-wire steering systems, the driver manual torque is currently predetermined on the basis of the steering rack force. This may be either the actual steering rack force (RFMD), the model-based steering rack force (RFMC), or a combination of these two forces. RFMD is calculated from internally measured variables. RFMC is determined purely model-based from the vehicle speed and steering rack position. This means that the customer sets the desired driver manual torque for the respective driving situation on the basis of a characteristic curve representing the manual torque over the steering rack force.

It is additionally provided that the return behavior is predetermined via a target return speed over the steering angle on the basis of the vehicle speed. This target return speed is controlled via a P regulator. Furthermore, the return functionality is reduced on the basis of the manual torque, so that the influence on the driver manual torque is lower. It must be taken into consideration that nonetheless, there is a lateral influence on the manual torque due to the active return, namely the function that actively resets the steering handle. In addition, the so-called CenterFeel functionality, a function that enables the driver to experience or feel the middle or center position of the steering handle, for example the steering wheel, provides an additional small build-up of manual torque from the steering center.

In addition, there are other functions that, however, have little impact on the static manual torque and are used unchanged. Examples of these further functions include hysteresis functionality, additional friction, additional inertia, etc.

As current solutions set the desired driver manual torque on the basis of the steering rack force and this steering force includes hysteresis and deceleration effects, additional functions must be included to compensate these deceleration and hysteresis functions in order to set the desired driver manual torque for the corresponding driving situation. In addition, the active return influences the driver manual torque, although it is actually only intended to define the return behavior. This makes it very difficult to determine the steering feel.

### DISCLOSURE OF THE INVENTION

Against this background, a method with the features of claim 1 and an arrangement according to claim 8 are presented. A computer program according to claim 9 and a machine-readable storage medium according to claim 10 are also presented.

The method presented serves to operate a steer-by-wire steering system in a vehicle, wherein the steering system is to be controlled via a steering handle and a driver manual torque, which comprises a static driver manual torque and a dynamic driver manual torque, is applied to the steering handle. This driver manual torque is used to provide feedback to the driver. The static driver manual torque, also referred to as the main torque, is felt by the driver at a constant steering angle and constant speed. The dynamic driver manual torque is felt by the driver at a changing steering angle and/or speed.

The driver manual torque is determined in the method on the basis of the driving situation of the vehicle. The static driver manual torque is calculated on the basis of steering angle and driving speed, particularly without taking into consideration the dynamic effects of steering rack force, i.e. these effects are not particularly considered or disregarded. Such effects result, for example, from the effect of the axle or damping. The steering rack force refers to the force on the steering rack arranged on the wheel adjuster.

The driving situation is defined, for example, by the speed of the vehicle and/or the steering wheel position.

In one embodiment, it is provided that the return of the steering wheel is performed solely or exclusively by the main torque. The active return function typically controls the return speed only when this return speed is above a predetermined speed. This predetermined speed may be predetermined by the plant or also by the driver.

In the method presented, the driver manual torque is thus predetermined on the basis of the driving situation, i.e., for example the vehicle speed and/or the steering angle, without deceleration and friction effects, and not on the basis of a steering rack force modeled on the real steering rack force. Thus, the influences of steering rack force side effects on the driver manual torque are avoided.

Furthermore, the CenterFeel function can be extended so that it defines the static driver manual torque on the basis of the driving situation.

Only in the parking or parking area can it be provided that the manual torque is defined on the basis of the estimated steering rack force. The parking area designates an area in which the vehicle travels at a speed of less than 10 km/h. This is expedient because the friction coefficient and the tires have a very large influence on the steering rack force in this area and there may not be a simple correlation for the desired manual torque via the steering angle.

It can further be provided that a factor and an offset to the static manual torque are predetermined in order to realize road feedback. In addition, the steering angle, which is the input for the CenterFeel and Active Return functions, can be provided with an offset, e.g. to realize overdriving.

In order to eliminate the influence of the active return on the nominal driver manual torque, the return concept is changed. Since no support is required in the steering wheel actuator (SWA) as is the case with standard EPS systems, the main support function, e.g. CenterFeel, is always sufficient to achieve the desired reset. This means that the Active Return function never has to actively reset, but only dampens when the desired return speed is exceeded. If the return controller only engages when the target return speed is exceeded, the Active Return function does not affect the static manual torque and is only used to limit the return speed to the predetermined return speed depending on the manual torque.

In addition, the P portion of the return controller may be reduced to 0 just before the steering center. This is typically done on the basis of a characteristic line.

The method presented has, at least in some embodiments, a number of advantages. These are:
simplified tuning,
no lateral influence,
the steering rack force calculation is only required for road feedback and does not influence the static steering feel, or the steering rack force calculation may be simplified such that a characteristic map of steering angle and driving speed is sufficient,
the concept is independent of the FeedForward control concept, i.e. only controlled or closed loop.

The described arrangement is used to carry out the presented method and is, for example, implemented in software and/or hardware. Furthermore, the arrangement can be integrated into a control unit of a vehicle or can be designed as such.

A steer-by-wire steering system with such an arrangement is further presented.

Further advantages and embodiments of the invention are shown in the description and the accompanying drawings.

It is understood that the abovementioned features and those to be explained below can be used not only in the combination indicated in each case, but also in other combinations or on their own, without departing from the scope of the present invention.

### BRIEF DESCRIPTION OF THE DRAWINGS

FIG. 1 shows a schematic diagram of an embodiment of a steering system.

FIG. 2 shows a highly simplified representation of a vehicle with an arrangement for carrying out an embodiment of the presented method.

FIG. 3 shows a flow chart of a possible sequence of the presented method.

### EMBODIMENTS OF THE INVENTION

The invention is illustrated schematically by means of embodiments in the drawings and is described in detail below with reference to the drawings.

FIG. 1 shows a highly simplified embodiment of a steer-by-wire steering system labeled with reference numeral 1. The steering system 1 comprises a steering handle 2 that can be operated by a driver and is configured as a rotatably mounted steering wheel 3. The steering handle 2 is mechanically connected to a manual torque adjuster 4, which is configured to monitor the rotational position of the steering wheel. The steering handle 2 and the manual torque adjuster 4 together form a steering unit 5, which is associated with a passenger compartment of a motor vehicle. The steering system 1 further comprises a wheel adjuster 6 comprising at least one steering rack and advantageously a track rod 7 coupled to pivotably mounted wheels of the motor vehicle associated with a wheel angle adjuster 8. An arrangement 9 for carrying out the method presented herein, which is e.g. configured as a control unit of the motor vehicle, is further provided.

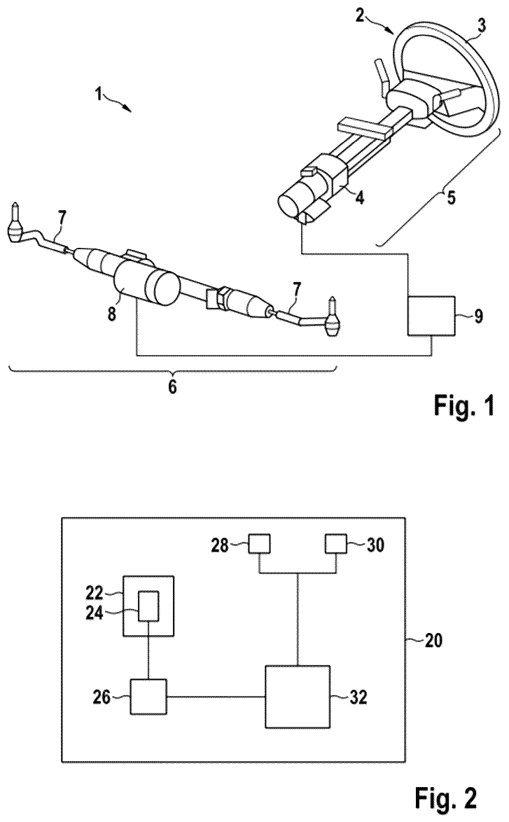

FIG. 2 shows a highly simplified and purely schematic representation of a vehicle, which is labeled with the reference number 20. A steer-by-wire steering system 22 is provided in this vehicle 20, to which a steering handling 24 is associated. An actuator (SWA) 26 may be used to apply a driver manual torque. The magnitude of this driver manual torque is determined by information regarding the driving situation. Thus, vehicle speed information may be captured with a first sensor 28 and steering angle information may be captured with a second sensor 30. This information represents or describes the driving situation. However, other magnitudes are conceivable for determining the driving situation.

An arrangement 32, in this case a control unit of the vehicle 20, captures the travel situation information, evaluates it, and controls the actuator 26 according to the particular travel situation, which in turn applies a driver manual torque to the steering handle 24.

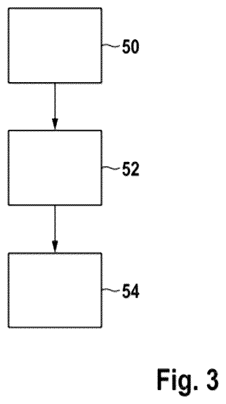

FIG. 3 shows a flow chart of a possible sequence of the presented method. In a first step 50, travel of a vehicle equipped with a steer-by-wire steering system begins, which in turn is to be controlled with a steering handle. In a next step 52, a driver manual torque, which may comprise a static driver manual torque and a dynamic driver manual torque, is determined on the basis of the driving situation of the vehicle. The static driver manual torque is calculated on the basis of the steering angle and driving speed, without taking into consideration dynamic effects of the steering rack force. In a step 54, the driver manual torque is then applied to the steering handle.

1. A method for operating a steer-by-wire steering system in a vehicle, comprising:
controlling the steering system via a steering handle;
applying a driver manual torque to the steering handle, the driver manual torque including a static driver manual torque and a dynamic driver manual torque;
determining the driver manual torque on the basis of a driving situation of the vehicle; and
calculating the static driver manual torque on the basis of a steering angle and a driving speed without taking into consideration dynamic effects of steering rack force.

2. The method according to claim 1, further comprising performing return of the steering handle exclusively by the static driver manual torque, wherein a function of the active return only regulates return speed if it is above a predetermined speed.

3. The method according to claim 2, further comprising employing a return controller for the return.

4. The method according to claim 1, further comprising determining the driver manual torque on the basis of an estimated steering rack force in a parking area.

5. The method according to claim 1, further comprising providing a factor and an offset to the static driver manual torque.

6. The method according to claim 1, further comprising providing the steering angle with an offset.

7. The method according to claim 1, further comprising defining the driving situation by the driving speed and/or the steering angle.

8. An arrangement for operating a steer-by-wire steering system, wherein the arrangement is configured for carrying out the method according to claim 1.

9. A computer program comprising program code configured to perform the method according to claim 1 when the computer program is executed on a computing unit.

10. A machine-readable storage medium having the computer program according to claim 9 stored thereon.
